(19) United States
(12) Patent Application Publication
(10) Pub. No.: US 2005/0028029 A1
(43) Pub. Date: Feb. 3, 2005

(54) Methods, apparatus, and computer program products for selectively backing up files to a robust storage medium according to program associations

(76) Inventor: Jim Thompson, Raleigh, NC (US)

Correspondence Address: Robert M. Meeks;Myers Bigel Sibley & Sajovec, P.A., Post Office Box 37428, Raleigh, NC, 27627, US

(21) Appl. No.: 10/926,562

(22) Filed: Aug. 26, 2004

Related U.S. Application Data
(63) Continuation-in-part of application No. 10/353,698, filed on Jan. 28, 2003.

(51) Int. Cl. G06F 11/00

(52) U.S. Cl. 714/6

(57) ABSTRACT

Files on a computer are selectively backed up to an external storage medium included in an uninterruptible power supply (UPS) that includes a UPS circuit that powers the external storage medium. A modification of a file resident at the computer is detected, and a decision is made as to whether to store the modified file on the external storage medium based on a program association of the file. For example, the modified file may be stored on the external storage medium if the modified file is a data file associated with a user application program, and storage of the modified file on the external storage medium may be foregone if the modified file is a data file associated with an operating system of the computer. The program association may be defined in a number of different ways, for example, responsive to a file attribute of the file, responsive to a content of the file and/or responsive to a user input.

### RELATED APPLICATIONS

The present application is a continuation-in-part of U.S. patent application Ser. No. 10/353,698, filed Jan. 28, 2003 (Attorney Docket No. 9060-200), the disclosure of which is incorporated herein by reference in its entirety. The present application is related to subject matter disclosed in U.S. patent application Ser. No. ______, entitled “METHODS, APPARATUS, AND COMPUTER PROGRAM PRODUCTS FOR SELECTIVELY BACKING UP VERSIONS OF FILES TO A ROBUST STORAGE MEDIUM ACCORDING TO FILE VERSION DIFFERENCES” (Attorney Docket No. 9060-241), filed concurrently herewith and incorporated by reference herein in its entirety.

### BACKGROUND OF THE INVENTION

The present invention relates to computer file management methods, apparatus and computer program products, and more particularly, to file backup methods, apparatus and computer program products.

A personal computer (PC) typically includes a disk drive or other storage device that stores data files that are manipulated by application programs, such as word processor or spreadsheet programs, which execute on the PC. In some environments, PC files may also be stored on an external storage device, such as a disk array, connected to the PC by a network. Backup software may save redundant copies of files stored on the PC's local hard drive to a backup storage device (e.g., tape drive, RAID device, etc.) such that, if the local disk drive fails, files may be restored from information held on the backup storage device. Many of these systems continually monitor the state of files on the local drive, and update the backed up information whenever a change is detected.

### SUMMARY OF THE INVENTION

In some embodiments of the invention, methods are provided for selectively backing up files on a computer to a external storage medium included in an uninterruptible power supply (UPS) that includes a UPS circuit that powers the external storage medium. A modification of a file resident at the computer is detected, and a decision is made as to whether to store the modified file on the external storage medium based on a program association of the file. For example, the modified file may be stored on the external storage medium if the modified file is a data file associated with a user application program, and storage of the modified file on the external storage medium may be foregone if the modified file is a data file associated with an operating system of the computer. The program association may be defined in a number of different ways, for example, responsive to a file attribute (e.g., filename, header, etc.) of the file, responsive to a content of the file and/or responsive to a user input.

In further embodiments, a difference between the modified file and previous version of the modified file stored on the external storage medium is determined. Determination as to whether to store the modified file on the external storage medium based on a program association of the file further may include determining whether to store the modified file on the external storage medium based on whether the determined difference meets a degree of difference criterion. In some embodiments, at least one of a time difference, a file size difference and/or a file content difference between a previous version of the modified file stored on the external storage medium and the modified file is determined. Determination as to whether to store the modified file on the external storage medium based on a program association of the modified file may further include determining whether to store the modified file on the external storage medium based on whether the determined at least one of a file time difference, a file size difference and/or a file content difference meets a predetermined criterion.

According to still further embodiments of the invention, an apparatus includes a computer configured to communicate with an uninterruptible power supply (UPS) that includes the external storage medium and a UPS circuit that powers the external storage medium. The computer is further configured to provide a program association selective file data storage agent operative to detect a modification of a file resident at the computer and to determine whether to store the modified file on the external storage medium based on a program association of the file.

In additional embodiments of the invention, a computer program product is provided for selectively backing up files on a computer to an external storage medium included in an uninterruptible power supply (UPS) that includes a UPS circuit that powers the external storage medium. The computer program product includes program code embodied in a computer-readable storage medium, the program code including program code configured to detect a modification of a file resident at the computer and program code configured to determine whether to store the modified file on the external storage medium based on a program association of the file.

### BRIEF DESCRIPTION OF THE DRAWINGS

FIG. 1 is a schematic diagram illustrating a computer configured to provide a file data storage agent according to some embodiments of the invention.

FIG. 2 is a schematic diagram illustrating a computer configured to provide a file data storage agent according to further embodiments of the invention.

FIGS. 3 and 4 are flowcharts illustrating exemplary file data storage operations according to further embodiments of the invention.

FIG. 5 is a flowchart illustrating an exemplary process for selective file data storage according to further embodiments of invention.

### DETAILED DESCRIPTION OF EXEMPLARY EMBODIMENTS

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like numbers refer to like elements. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries; should be interpreted as having a meaning that is consistent with their meaning in the context of the relevant art and will not be interpreted in an idealized or overly formal sense unless expressly so defined herein.

Some embodiments of the invention described herein relate to storage of file data from a computer to an external storage device. As referred to herein, “computer” includes any of a variety of computing devices, including, but not limited to, personal computers (PCs), computer workstations, servers, computer-based communications devices, and electronic modules that have computing capabilities.

As will be appreciated by one of skill in the art, the invention may be embodied as apparatus, methods and computer program products. Embodiments of the invention may include hardware and/or software. Furthermore, the invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the invention may be written in an object oriented programming language such as Java®, Smalltalk or C++. However, the computer program code for carrying out operations of the invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The invention is described below with reference to block diagrams and/or operational illustrations of methods, apparatus and computer program products according to various embodiments of the invention. It will be understood that each block of the block diagrams and/or operational illustrations, and combinations of blocks in the block diagrams and/or operational illustrations, can be implemented by analog and/or digital hardware, and/or computer program instructions. These computer program instructions may be provided to a processor of a general purpose computer, special purpose computer, ASIC, and/or other programmable data processing apparatus, such that the instructions, which execute via the processor of the computer and/or other programmable data processing apparatus, create means for implementing the functions/acts specified in the block diagrams and/or operational illustrations. In some alternate implementations, the functions/acts noted in the figures may occur out of the order noted in the block diagrams and/or operational illustrations. For example, two operations shown as occurring in succession may, in fact, be executed substantially concurrently or the operations may sometimes be executed in the reverse order, depending upon the functionality/acts involved.

Co-pending U.S. patent application Ser. No. 10/353,698 describes a uninterruptible power supply (UPS) with an integrated storage medium that can be used to provide backup storage for a PC or other computer. As described in the aforementioned application, a file data storage agent may be configured to store files on a UPS that includes an integrated storage medium that is powered by the UPS. The file data storage agent may provide a user interface that allows a user to mark selected files for backup. The file data storage agent may responsively store data from the marked files in the external storage medium of the UPS-based file data storage apparatus. Data transfer to the external storage medium may be triggered by, for example, a status change of the UPS, e.g., by a failure or degradation of an AC power source that feeds the UPS, or by other events.

Some embodiments of the invention arise from a realization that, for a backup storage application such as that described in the aforementioned U.S. patent application Ser. No. 10/353,698, the amount of backup storage may be limited and, accordingly, it may be desirable to store only those files that are of particular interest, e.g., files that are “more important” than others. For example, a disk operating system (DOS) typically is continually engaged in opening, reading and writing to files. Many of these files may be files that are used by the operating system itself, such as memory files, device drivers, and internal programs (e.g., schedulers and memory managers). These files may be modified thousands of times during a typical day's operation. Changes to such files typically are of little interest. In contrast, changes to data files associated with application programs, such as word processors, spreadsheets and databases, may be of more critical importance.

According to some embodiments of the invention, files may be selectively backed up to an external storage device using a program association criterion. For example, using a file association list or other means for associating a file with a program, such as an application program, a file storage agent can selectively store files that are associated with programs that are more likely to be dealing with data files of critical interest, such as documents, spreadsheets and the like.

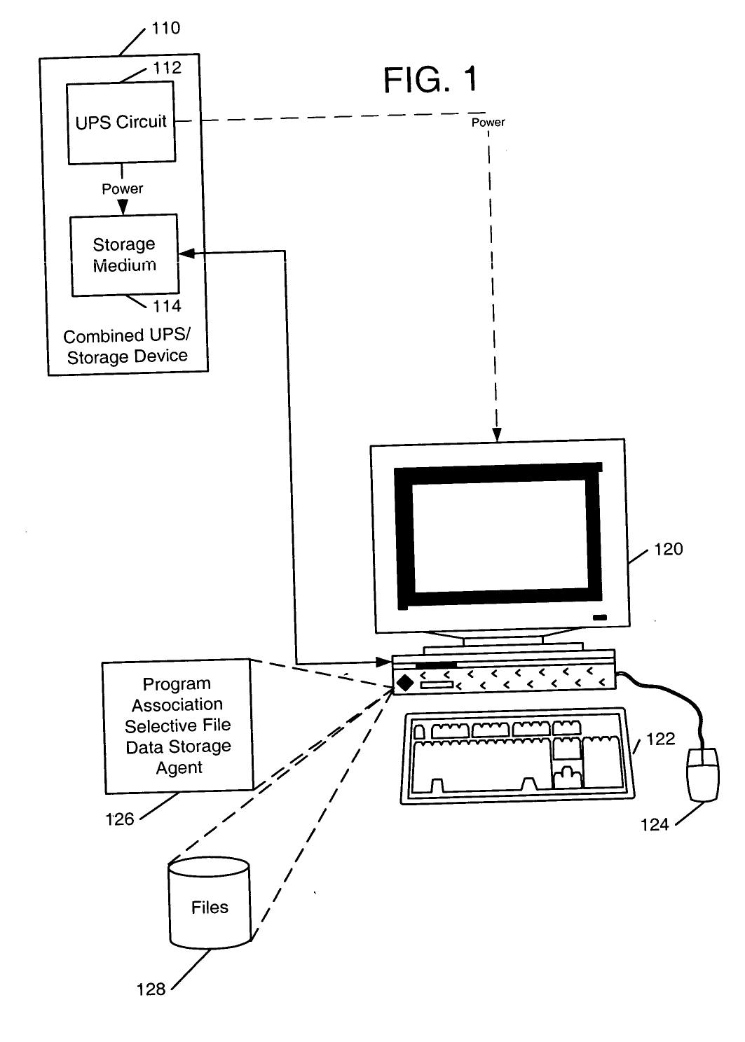

FIG. 1 illustrates an apparatus according to some embodiments of the present invention, in particular, a computer 120 configured to selectively store files 128 resident on the computer 120 on an external storage medium 114 integrated in a UPS 110. The UPS 110 includes a UPS circuit 112 that powers the storage medium 114 to provide robust backup storage, and which may also, optionally, provide power to the computer 120. The computer 120 is configured to provide a program association selective file data storage agent 126 that selectively backs up versions of the files 128 based on program associations of the files 128.

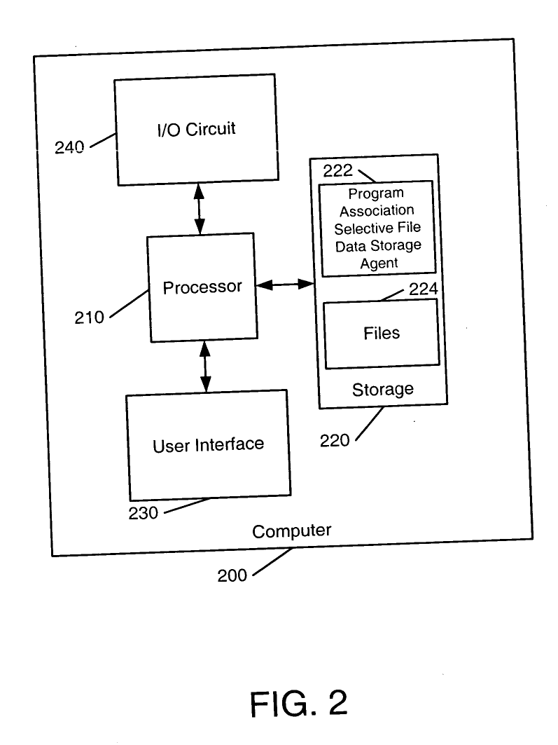

FIG. 2 illustrates an exemplary implementation of a program association selective file data storage agent. A computer 200 includes a processor (e.g., a microprocessor) that is operatively associated with an input/output (I/O) circuit 240 and a user interface circuit 230. It will be appreciated that the I/O circuit 240 may include, for example, wireline, optical and/or radio interface circuitry that enables the processor 210 to communicate with external devices, such as the integrated UPS/storage medium 110 of FIG. 1. The user interface circuit 230 may include, for example, display and input device circuitry (e.g., mouse and/or keyboard). The computer 200 further includes storage 220 that is configured to store data and program code that is executed or manipulated by the processor 210. It will be appreciated that the storage 220 may include, for example, random access memory (RAM), read-only memory (ROM), and bulk storage, such as a magnetic disk, bubble memory. As shown, a program association selective file data storage agent 222 may include an application program that is resident in the memory 220 and executable on the processor 210. Files 224 that are created and/or manipulated by other application programs (not shown) and selectively backed up by the program association selective file data storage agent may also be stored in the storage 220.

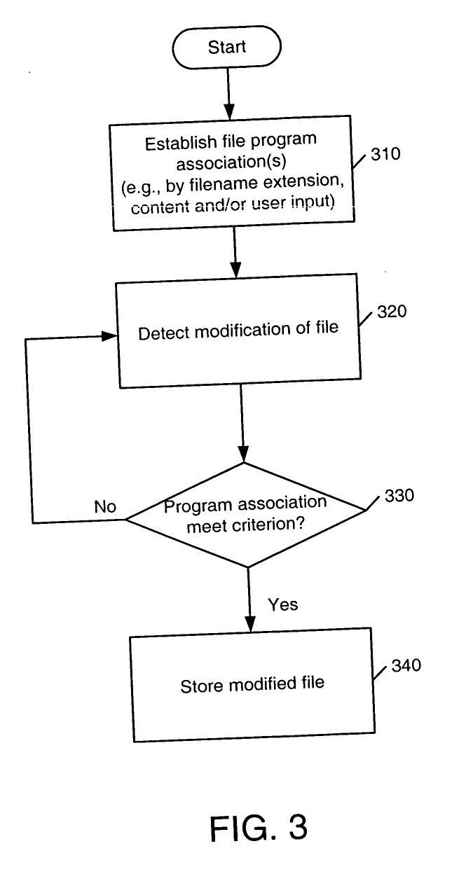

FIG. 3 illustrates exemplary file data storage operations according to further embodiments of the present invention. Program associations are established for one or more files (block 310). For example, file program associations may be established by filename extension, as traditionally done in various versions of the Windows® operating system distributed by Microsoft® Corporation, Redmond, Wash. It will be appreciated that other techniques for creating file program associations may also be used with the invention, such as techniques wherein file program associations are created responsive to user selections and/or techniques wherein program associations are created by examining file content. It will be understood that a file program association may be established by creating a file association list or other data structure that cross-references a file or file type to a particular program and/or may be defined by default by an operating system and/or application programs themselves based, for example, on file attributes, such as filenames, file headers, and the like.

Still referring to FIG. 3, a modification of a file is detected, e.g., by checking file content and/or by detecting a file write or other operation that causes a file modification (block 320). If the program association of the modified file meets a predetermined criterion (block 330), the modified file is stored on the external storage medium (block 340). If not, no storage operation occurs, and the process awaits a new file modification event. It will be appreciated that the program association criterion may take any of a number of different forms. For example, in some embodiments of the invention, the criterion may require that only files associated with certain application programs, such as word processors, spreadsheets, databases and the like, be stored on the external storage medium, while files with other program associations, such as operating system files, are not backed up.

According to further embodiments of the present invention, use of a program association criterion to guide file data backup may be combined with other criteria, such as those described in U.S. patent application Ser. No. ______, entitled “METHODS, APPARATUS, AND COMPUTER PROGRAM PRODUCTS FOR SELECTIVELY BACKING UP VERSIONS OF FILES TO A ROBUST STORAGE MEDIUM ACCORDING TO FILE VERSION DIFFERENCES” (Attorney Docket No. 9060-241). In particular, degree of difference criteria, such as a time difference criterion, a file size difference criterion and/or a file content difference criterion, may be combined with a file program association criterion along the lines discussed above, to guide backup of file data on an external storage device, such as the UPS-based device 110 of FIG. 1.

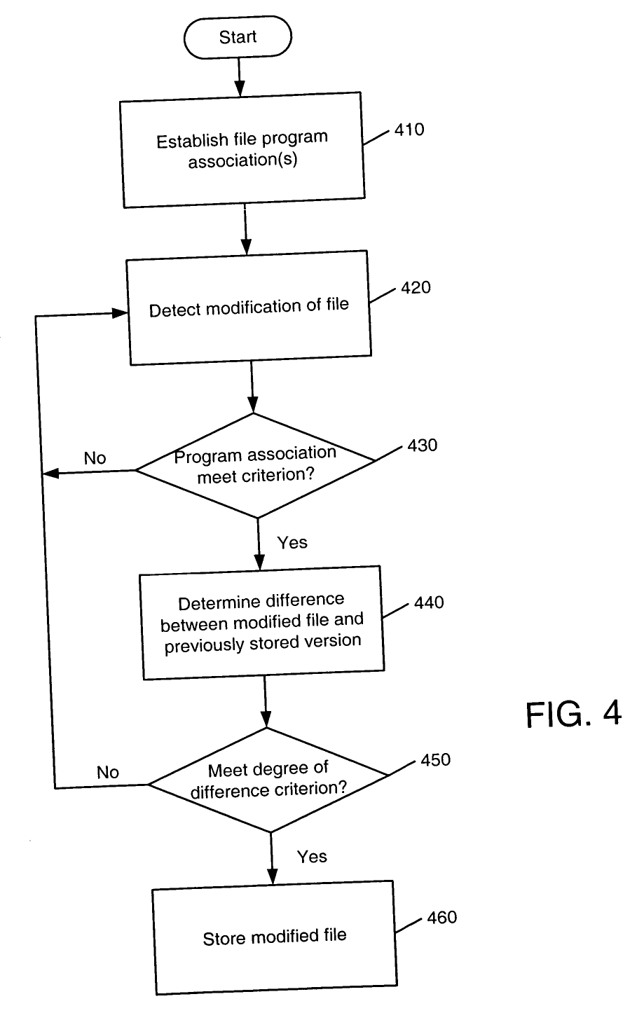

FIG. 4 illustrates exemplary file data storage operations using such combined criteria according to further embodiments of the invention. Program associations are established for one or more files (block 410). A modification of a file is detected (block 420). If the file's program association meets a predetermined criterion (block 430), a difference between the modified file and a previously stored version of the modified file is determined (block 440). If the difference meets a predetermined degree of difference criterion (block 450), the modified file is stored (block 460). If the modified file does not have an appropriate program association or does not meet the degree of difference criterion, the modified file is not stored.

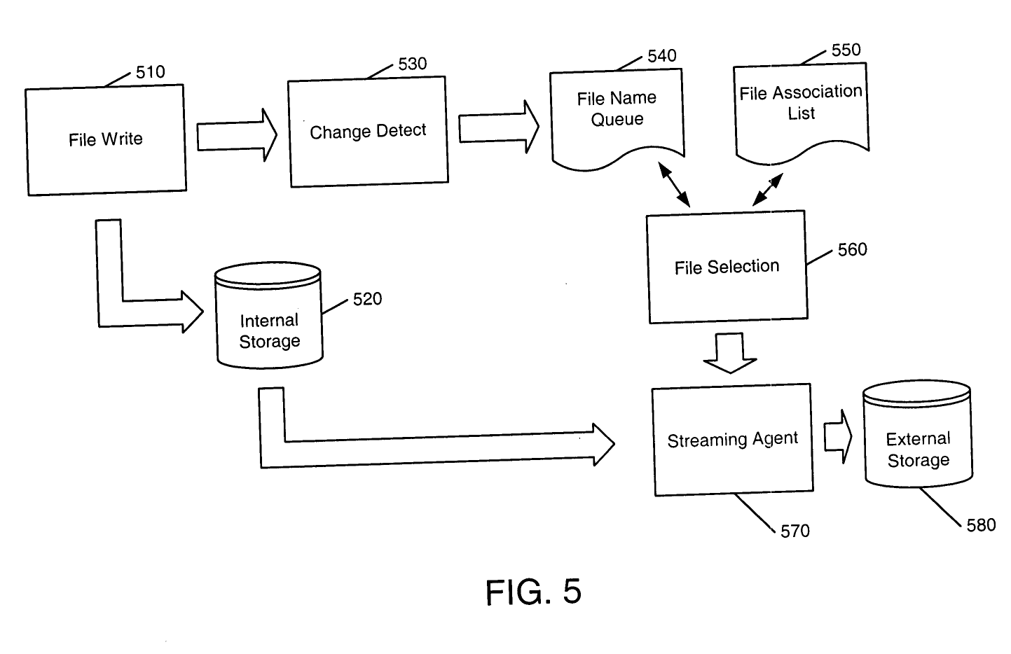

FIG. 5 illustrates an exemplary process for storing file data on an external storage medium according to further embodiments of the invention. A file write process 510 transfers file data to an internal storage medium 520, for example, an internal hard disk. A change detect process 530 detects operation of the file write process 510, and responsively provides information on the file being modified to a file name queue 540 (e.g., a file that includes a list of names of modified files). A file selection process 560 evaluates the files in the file name queue 540 in light of a file association list 550, i.e., a list that associates files with particular programs, and indicates to a streaming agent process 570 which files stored on the internal storage medium 520 are to be stored on an external storage medium 580.

The flow diagrams and block diagrams of FIGS. 1-5 illustrate architecture, functionality, and operations of possible implementations of apparatus, methods and computer program products according to various embodiments of the present invention. It should also be noted that, in some alternative implementations, the acts noted in the diagrams may occur out of the order noted in the figures. For example, two operations shown in succession may, in fact, be executed substantially concurrently, or the operations may sometimes be executed in the reverse order, depending upon the functionality involved.

In the drawings and specification, there have been disclosed typical illustrative embodiments of the invention and, although specific terms are employed, they are used in a generic and descriptive sense only and not for purposes of limitation, the scope of the invention being set forth in the following claims.

1. A method of selectively backing up files on a computer to a external storage medium included in an uninterruptible power supply (UPS) that includes a UPS circuit that powers the external storage medium, the method comprising:
detecting a modification of a file resident at the computer; and
determining whether to store the modified file on the external storage medium based on a program association of the file.

2. A method according to claim 1, further comprising defining the program association of the file responsive to a file attribute of the file.

3. A method according to claim 1, further comprising defining the program association of the file responsive to a content of the file.

4. A method according to claim 1, further comprising defining the program association of the file responsive to a user input.

5. A method according to claim 1, further comprising storing the modified file on the external storage medium if the modified file is a data file associated with a user application program.

6. A method according to claim 1, further comprising foregoing storage of the modified file on the external storage medium if the modified file is a data file associated with an operating system of the computer.

7. A method according to claim 1, further comprising determining a difference between the modified file and previous version of the modified file stored on the external storage medium, and wherein determining whether to store the modified file on the external storage medium based on a program association of the file further comprises determining whether to store the modified file on the external storage medium based on whether the determined difference meets a degree of difference criterion.

8. A method according to claim 1, further comprising determining at least one of a time difference, a file size difference and/or a file content difference between a previous version of the modified file stored on the external storage medium and the modified file, and wherein determining whether to store the modified file on the external storage medium based on a program association of the modified file further comprises determining whether to store the modified file on the external storage medium based on whether the determined at least one of a file time difference, a file size difference and/or a file content difference meets a predetermined criterion.

9. An apparatus, comprising:
a computer configured to communicate with an uninterruptible power supply (UPS) that includes the external storage medium and a UPS circuit that powers the external storage medium, the computer further configured to provide a program association selective file data storage agent operative to detect a modification of a file resident at the computer and to determine whether to store the modified file on the external storage medium based on a program association of the file.

10. An apparatus according to claim 9, further comprising means for defining the program association of the file responsive to a file attribute of the file.

11. An apparatus according to claim 9, further comprising means for defining the program association of the file responsive to a content of the file.

12. An apparatus according to claim 9, further comprising means for defining the program association of the file responsive to a user input.

13. An apparatus according to claim 9, wherein the program association selective file data storage agent is operative to store the modified file on the external storage medium if the modified file is a data file associated with a user application program.

14. An apparatus according to claim 9, wherein the program association selective file data storage agent is operative to forego storage of the modified file on the external storage medium if the modified file is a data file associated with an operating system of the computer.

15. An apparatus according to claim 9, wherein the program association selective file data storage agent is further operative to determine a difference between the modified file and previous version of the modified file stored on the external storage medium and to determine whether to store the modified file on the external storage medium based on whether the determined difference meets a degree of difference criterion.

16. An apparatus according to claim 9, wherein the program association selective file data storage agent is further operative to determine at least one of a time difference, a file size difference and/or a file content difference between a previous version of the modified file stored on the external storage medium and the modified file and to determine whether to store the modified file on the external storage medium based on whether the determined at least one of a file time difference, a file size difference and/or a file content difference meets a predetermined criterion.

17. A computer program product for selectively backing up files on a computer to an external storage medium included in an uninterruptible power supply (UPS) that includes a UPS circuit that powers the external storage medium, the computer program product comprising program code embodied in a computer-readable storage medium, the program code comprising:
program code configured to detect a modification of a file resident at the computer; and
program code configured to determine whether to store the modified file on the external storage medium based on a program association of the file.

18. A computer program product according to claim 17, wherein the computer readable program code further comprises:
program code configured to determine a difference between the modified file and previous version of the modified file stored on the external storage medium; and
program code configured to determine whether to store the modified file on the external storage medium based on whether the determined difference meets a degree of difference criterion.

19. A computer program product according to claim 17, wherein the computer readable program code further comprises:
program code configured to determine at least one of a time difference, a file size difference and/or a file content difference between a previous version of the modified file stored on the external storage medium and the modified file; and
program code configured to determine whether to store the modified file on the external storage medium based on whether the determined at least one of a file time difference, a file size difference and/or a file content difference meets a predetermined criterion.
